(19) United States
(12) Patent Application Publication
(10) Pub. No.: US 2008/0057483 A1
(43) Pub. Date: Mar. 6, 2008

(54) Apparatus and System for Testing Memory

(76) Inventor: LAWRENCE H AVIDAN, SAUSALITO, CA (US)

Correspondence Address: PROCENTRIS, INC., 1001 BRIDEWAY, # 995, SAUSALITO, CA, 94965, US

(21) Appl. No.: 11/469,903

(22) Filed: Sep. 5, 2006

(51) Int. Cl. G09B 7/00

(52) U.S. Cl. 434/362

(57) ABSTRACT

Different memory testing devices, systems, and methods for conducting memory tests, and for storing and displaying test data and trends are disclosed. The tests generally are based on generating a random sequence of signals, displaying the sequence to an examinee, the examinee memorizing the sequence, and inputting the sequence into the testing device. The signals could have visual, auditory, positional, and/or tactile components. The signals could also be alphanumeric strings.

The testing device measures test outcome variables, computes a composite memory score based on the test outcome variables, records and displays the stored test data. The testing device may also include a communication interface for periodically transferring the stored test data to a database residing on a remote server displaying the test data of the examinee on a website through an internet connection

The testing device need not be a physical device. Instead, it is possible to implement the functionality of the testing device in a virtual device which is basically a software application, installed and used on a personal computer, a mobile phone, a PDA, etc.

### BACKGROUND OF THE INVENTION

1. Field of the Invention

The invention relates to the field of memory-testing devices, more particularly the field of memory testing devices that are network-enabled and that enable remote monitoring of test results.

2. Description of the Related Art

Dementia is a syndrome of progressive decline in multiple domains of the cognitive function, eventually leading to an inability to maintain normal social and/or occupational performance. Dementia is considered to be a major public health challenge since the median age of the industrialized world's population is increasing steadily. It is estimated that within the next 20 years, one in every five persons in the United States will be over the age of 65.

At present, Alzheimer's disease (AD) is the most common form of dementia, afflicting approximately 4 million Americans. The cost to the U.S. society is estimated to be at least $100 billion every year, making AD the third most costly disorder of aging. Advancing age is the primary risk factor for AD. Among people aged 65, 2-3% show signs of the disease, while 25-50% of people aged 85 have symptoms of Alzheimer's. Every five years after the age of 65, the probability of having the disease doubles. The proportion of people with Alzheimer's begins to decrease after age 85 because of the increased mortality due to the disease, and relatively few people over the age of 100 have the disease.

The most striking early symptom of AD is short-term memory loss (amnesia), which usually manifests as minor forgetfulness that becomes steadily more pronounced as the illness progresses, with relative preservation of older memories. As the disorder progresses, cognitive (intellectual) impairment extends to the domains of language (aphasia), skilled movements (apraxia), recognition (agnosia), and decision-making.

Early identification is critical in progressive conditions such as dementia, because early treatment may be more effective than later treatment in preserving the cognitive function. However, in early stages, there is no major problem in daily life, and it is difficult to detect dementia.

A variety of tests has been used for diagnosing dementia in general and AD in particular. Examples of such tests include the abbreviated mental test score (AMTS) and the mini mental state examination (MMSE). These tests are, however, influenced by the patient's educational level.

Usually the tests are administered manually and consist of face-to-face testing in a testing site such as a physician's office. Aside from the traditional face-to-face testing, there are computer-implemented techniques for cognitive testing, for example, Neurobehavioral Evaluation System (NES2).

A major problem with the currently practiced manual and computer-implemented tests is the low frequency of the tests. The testing frequency is governed by the convenience or ability of the person to travel to the testing site.

Repeated testing on a regular basis is needed to monitor trends in memory. For example, it may be desired to evaluate the impact of alternative drug-based therapies, behavioral therapies, or any other therapies for dementia or AD. Regular monitoring of memory could reveal subtle changes, which may be missed out in infrequent testing. It may also enable detection of undesirable side effects and allow timely intervention by a therapist.

U.S. Pat. No. 4,359,220 discloses a microcomputer-controlled game utilizing a microprocessor for controlling the play of one or more games in which a participant may play against the machine or against another participant. The game includes a portable housing having a top surface subdivided into a plurality of playing areas, each of which playing areas has two manually operable push buttons, and having a microprocessor within the housing. The microprocessor is located in the housing to control the illumination of the push buttons by light sources located below the top surface of the housing and to control the emission of distinct tones by a loudspeaker during the play of the games. However, this patent teaches only a game and does not teach how to measure cognitive capacity.

U.S. Pat. No. 4,755,140 discloses an electronic personnel test device wherein a hand calculator provides an indicator of a subject's reaction time. An array of push-button keys has programmable varied numerals, which do not correspond to an orderly presentation. A display on the device instructs that a particular sequence of numbers be touch-indicated by the subject within a certain period of time. The touched sequence and time elapsed provides an indication of the subject's reaction time which could be influenced by fatigue, ill health and drug, including alcohol, use so that the subject's effectiveness for a particular duty can be evaluated. The device disclosed in this patent measures the reaction time of an examinee, but it does not teach how to measure memory and/or cognition capacity.

U.S. Pat. No. 4,770,636 discloses a cognometer, which is programmed for repeated, rapid, automated assessment and monitoring of memory and concentration. The memory monitor randomly generates data and displays the same in a common format, tests the user's comprehension of such data, tests the immediate recall of such data, and tests the delayed recall of such data. The concentration monitor randomly generates a long multi-digit number and displays the same, tests the user's comprehension of such number, and tests the concentration of the user by requiring the user to enter such number while the number is displayed, but without any position cue. However, this patent does not teach how to store test outcome variables and test scores, how the test results could be transmitted to a remote server, and how the results could be accessed in real-time by a medical practitioner or any authorized person.

U.S. Pat. No. 6,565,359 discloses a computer-implemented method and apparatus for remote cognitive and/or perceptual testing using a computer network having a remote computer geographically separate from an administering computer. The remote cognitive and/or perceptual testing includes administering a set of cognitive and/or perceptual tests, obtaining a performance response of the person to the tests and uploading the testing information via the computer network. The tests may be administered a number of times to evaluate one or more cognitive skills and/or perceptual abilities. Parallel to the testing, a therapy may be administered. The method may also include monitoring the performance of the person on the tests. The computer-implemented method may additionally include administering a set of initial tests before therapy inception to assess a person's intrinsic cognitive skills and/or perceptual abilities. The results of the initial testing and testing during therapy may be entered into a database. The database may be built from the performance response of multiple people and may be useful in predicting efficacy of a proposed therapy. However, this patent does not teach any specific memory measuring device or method nor does it teach how to transmit test results from a portable device to a server.

U.S. Pat. No. 6,654,695 discloses a dementia test system and the like for testing a dementia degree of a testee, and provides a dementia test system which is effective for preventing and finding, at early stage, an initial sign (initial dementia) of senile dementia. A dementia test apparatus comprising an answer obtaining section 131 for obtaining an answer of a testee to both a dementia degree test chart which requires a plurality kinds of judgment at the same time and obtains an answer in such a form that correction of judgment is objectively judged, and a dementia factor degree test chart comprising a combination of a plurality of question concerning sensibility and a plurality of answers alternatively selected from questions prepared for each of the former questions, and a dementia degree test section 132 for testing a dementia degree indicative of a current degree of dementia of the testee based on an answer obtained by the answer obtaining section, and for estimating transition of future dementia degree of the testee. However, this patent does not teach how the test results could be transmitted to a remote server, and how the results could be accessed in real-time by a medical practitioner or any authorized person.

U.S. Pat. No. 7,070,563 discloses memory tests using item-specific weighted memory measurements and uses thereof wherein a method of increasing the usefulness, sensitivity and specificity of tests that measure memory and facets of memory, including learning retention, recall and/or recognition. Specifically, the sensitivity and specificity of such tests are enhanced by selectively weighting the value of specific items recalled by the test subject, either by weighting such items within any specific testing trial or across numerous testing trials. Also disclosed are various methods of reducing ceiling effects in memory tests. The invention also provides improved tests which employ item-specific weighting for the diagnosis of Alzheimer's Disease and other dementia characterized by memory impairment, as well as a method of screening for and evaluating the efficacy of potential therapeutics directed to the treatment of such dementia. However, this patent does not teach how to store test outcome variables and test scores, how the test results could be transmitted to a remote server, and how the results could be accessed in real-time by a medical practitioner or any authorized person.

US Publication No. 2003/0009088 discloses a monitoring system for patients with at least one measuring device for medical and diagnostic values of the patient such as blood pressure, pulse, body temperature, blood sugar and the like, which measuring device is carried and operated by the patient. The invention proposes that the measuring device feature at least one transmitter for the wireless transmission of the recorded values to at least one local receiver. In this arrangement, it is particularly advantageous if the receiver is integrated into a mobile phone, which sends the recorded values to a central data processing device via a mobile telephone network. However, the publication does not teach about any memory-measuring device.

US Publication No. 2005/0053904 discloses a system and method for on-site cognitive efficacy assessment for determining diminishment in brain function in relation to at least one of specific adverse factors and specific tasks. The system involves establishing threshold levels for at least one brain function that is either affected by specific adverse factors or is used to perform specific tasks, or both. A test-taker is given a battery of tests from a portable testing unit, where the tests have been tailored to measure specific cognitive functions that can be affected by adverse factors, cognitive functions that are required to perform specific tasks, or both. Scores from the tests are compared to the threshold levels required to perform a task, and a determination is made concerning the capability of the individual to handle the task(s) in question. The portable testing unit may be connected to equipment whose use is denied for test results that fall below a normative level for the activity. However, the publication does not teach about a memory measurement device.

US Publication No. 2006/0074340 discloses a cognitive capacity measurement device and cognitive capacity measurement method to measure the cognitive capacity to reconstruct from incomplete data original data explainable by correspondence to brain function, to apply these results to conduct research on brain function and in the future to select and determine the suitability of training appropriate to each individual, and to contribute to early detection, etc. of diseases related to cognitive function such as Alzheimer type dementia, is made such that: a degraded image, which is an image for which specified processing has been conducted on an original image having a significant photographic object and the data for recognizing the aforementioned photographic object has been degraded, is displayed to a subject; the fact that the aforementioned photographic object has been recognized is received from the subject; the recognition time, which is the time required for the subject to recognize the aforementioned photographic object, is calculated based on these received results; and the cognitive capacity score, which is an index that digitizes the cognitive capacity of the subject by specified computations, is calculated from this recognition time and the challenge level data, which is data related to the challenge level of the aforementioned degraded image in conjunction with the recognition of the photographic object. However, this publication does not teach how to store test outcome variables and test scores, how the test results could be transmitted to a remote server, and how the results could be accessed in real-time by a medical practitioner or any authorized person.

It is desirable if memory testing is user-friendly and if testing can be performed at home by an examinee him/herself. It is also desirable if medical practitioners and/or family members can monitor the examinee's performance remotely as frequently as desired.

It should also be possible to evaluate an individual's memory by his or her own previous performance, rather than only by the less sensitive comparison with the performance of others.

It is also desirable if the testing can be a fun exercise for the examinee, thus providing an incentive to the examinee to perform the tests regularly. It is also desirable if the tests are intellectually stimulating.

It is also desirable if the device is portable and can run on both batteries and regular power supply. It is also desirable that the examinee does not have to deal with the complexity of computers and network connections. Instead, it is preferable if test results could be automatically transmitted without requiring cumbersome actions on the part of the examinee.

### SUMMARY OF THE INVENTION

The disclosed invention has been conceived and developed to overcome the limitations of previous cognition capacity testing devices and systems, particularly for patients suffering from dementia in general or from specific types of dementia, for example, Alzheimer's disease or Parkinson's disease.

One of the objects of the present invention was to develop a testing device, which was light, portable, and easy to use so that it could be used by patients to test their memory on their own in a home setting. It was also an object of the invention to develop a device which can be used for testing memory, and which at the same time should be fun to use and also provide intellectual stimulation. It has been reported that participation in intellectually stimulating activities like chess and crossword puzzles before the onset or in the initial stages of dementia can arrest the progression of the disease.

Another object of the invention was to develop methods for computing composite memory scores, which would be able to detect early stages of the disease with high specificity and sensitivity, because therapy is more effective in early stages of the disease.

It was also an object of the invention to enable performance of repeated and regular testing and to record the test outcome variables and composite memory scores in a convenient manner in an embedded memory medium in the testing device. The historical scores based on regular testing over a period of time for each examinee could be used to assess the progression of disease and also to provide objective feedback to therapists to evaluate the efficacy of alternative therapies.

It was also an object to be able to transmit the test outcome variables and composite memory scores of each examinee to a database on a remote server so that that medical practitioners, family members, and other authorized persons could monitor the performance of the examinees remotely using internet capable devices.

The disclosure describes different embodiments of a memory testing device for conducting memory tests based on generating a random sequence of signals, displaying the sequence to an examinee, and the examinee memorizing and inputting the sequence into the testing device. In an embodiment of the invention, the examinee selects a test variant and a test level. As the test progresses, the testing device measures test outcome variables and computes a composite memory score (hereinafter called a composite score) based on the test variant, the test level, and the test outcome variables. The testing device records the composite scores in a memory medium and displays the composite score to the examinee. Another embodiment of the testing device also includes a communication interface (for example, a modem), which can be used for periodically transferring the stored test data from the memory medium to a database residing on a remote server.

Another embodiment of the testing device generates and displays a random sequence of signals, which could be a combination of visual, auditory, positional, and/or tactile components. The examinee is supposed to memorize the sequence and input the sequence into the testing device in the same order. The testing device may have buttons/switches, etc. located on control panel and/or operative panels for controlling and operating the device. The testing device may have different shapes, for example, circular, square, rectangular, etc. A variety of test outcome variables can be measured, for example, total string length, length of a signal tone, duration before starting input, average duration between inputs, maximum duration between any two inputs, duration between signal tones, etc.

Another embodiment of the testing device generates and displays a random alphanumeric string to the examinee, the examinee recalls the alphanumeric string and inputs the alphanumeric string into the testing device using a keypad. In this embodiment, a variety of test outcome variables can be measured, for example, total string length, duration of display of the alphanumeric string, duration before starting input, average duration between inputs, maximum duration between any two inputs, etc.

In another embodiment of the testing device, there are disclosed control switches and/or button to select test variants and test levels. In another embodiment, the test variants and test levels could also be changeable automatically based on composite score data and composite score trends of the examinee.

In another embodiment of the invention, a memory measurement system is disclosed. The system comprises a memory-testing device including a memory medium and a communication interface, a score-computing module, and an internet capable device for accessing the database and for displaying the test data of the examinee on a website through an internet connection. The score-computing module may reside either on the testing device or on the remote server. The score computing module can compute composite memory scores, composite score time series, and/or composite score trend charts for each examinee based on the test levels and test outcome variables of the examinee.

The disclosure also describes a method for conducting memory measurement tests comprising the steps of selecting a test variant and a test matrix, measuring test outcome variables, computing composite memory scores, composite score time series, and composite score trend charts for each examinee. The composite scores are computed based on the test matrix and the test outcome variables, and normalization factors for learning effect, gender, and age of the examinee.

In another embodiment of the invention, the method also includes the steps of periodically transmitting, via a communication interface, the test data for each examinee from the testing device to a database residing on a remote server and displaying the test data to medical practitioners, family members, other authorized persons, etc. on a website accessible through an internet capable device.

### BRIEF DESCRIPTION OF THE DRAWINGS

Preferred embodiments are illustrated by way of example, and not by way of limitation, in the accompanying drawings and in which like reference numerals refer to similar elements and in which:

FIG. 1 provides an illustrative overview of an embodiment of a memory-testing device.

FIG. 2 shows an embodiment of an operative panel of a memory-testing device.

FIG. 3 provides another embodiment of an operative panel of a memory-testing device.

FIG. 4 provides yet another embodiment of an operative panel of a memory-testing device.

FIG. 5 provides another embodiment of an operative panel of a memory testing device n.

FIG. 6 shows a flow diagram illustrating the process flow for working of a memory testing device.

FIG. 7 illustrates an architectural view of an embodiment of a system for recording, transmitting, and displaying composite memory Scores.

FIG. 8 illustrates an architectural view of another embodiment of a system for recording, transmitting, and displaying composite memory scores.

FIG. 9 shows an overview of the process for calculation of a composite score by the score-computing module.

### DETAILED DESCRIPTION OF EMBODIMENTS

In the following description of various embodiments including the preferred embodiment, reference is made to the accompanying drawings, which show by way of illustration the embodiments in which the invention may be practiced. It is to be understood that other embodiments may be utilized and structural and functional modifications may be made without departing from the spirit or scope of the invention. Those skilled in the art will readily appreciate that the detailed description given herein with respect to these drawings is for explanatory purposes as the invention extends beyond these limited embodiments.

A variety of tests can be generated by varying the combinations of different types of stimuli, for example, visual stimuli, auditory stimuli, positional stimuli, vibratory stimuli, etc. Tests can also be generated by varying the level of difficulty. The memory score may be better determined by conducting not a single test, but a battery of multiple tests designed to test response to different stimuli. The battery of tests given to the examinee is also known as a test matrix.

There is a natural variation of memory even among normal persons because of age and gender. Therefore, the absolute scores generated by the testing device need to be adjusted by normalization factors for age and gender. Similarly, it has been observed that there is generally an initial improvement in absolute scores of most examinees during an initial learning period, followed by a subsequent leveling of the scores. This type of improvement in the scores is known as learning effect. The absolute scores generated by the testing device need to be also adjusted by normalization factors for learning effect.

The memory scores are affected by the combination of stimuli observed by the examinee. The tests can be based on different combinations of stimuli, for example, visual, auditory, positional, and vibratory stimuli. The absolute scores generated by the testing device need to be also adjusted for this factor.

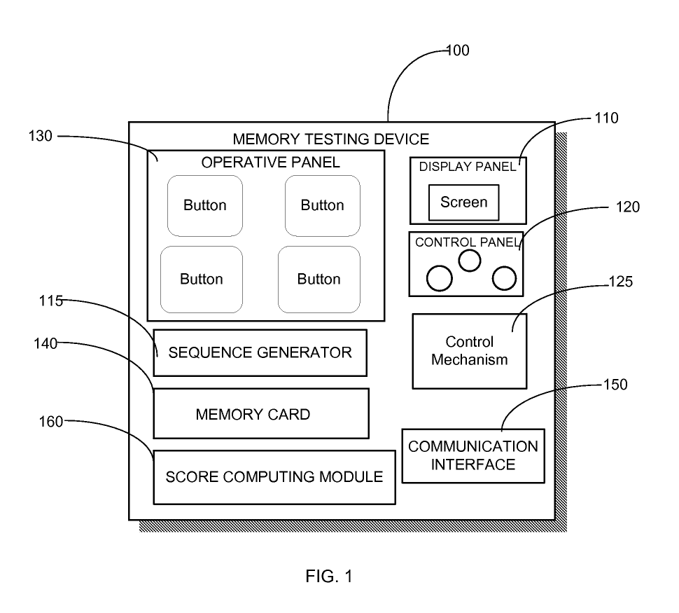

FIG. 1 shows an illustrative overview of an embodiment of a testing device as disclosed herein. The embodiment discloses a memory testing device 100 (hereinafter called testing device), generally used for testing and monitoring the memory of an examinee. The testing device 100 can be of any geometric shape, such as square, rectangular, circular, triangular, elliptical etc. An examinee can be a healthy individual of any age group or a patient suffering from dementia or any other cognitive impairment condition. The testing device 100 includes, a display panel 110, a mechanism for generating a random sequence of signals (hereinafter called a sequence generator 115), a control panel 120 with a set of control switches, a control mechanism 125, an operative panel 130 with a plurality of buttons, switches, etc., a memory medium 140, a communication interface 150, and a score computing module 160.

A test variant is a type of test, which is designed for a specific group of examinees. For example, a color selection variant is a test variant in which a sequence of colors is displayed to an examinee and is designed for all persons not having any visual impairment condition. Similarly, a pattern selection variant is a test variant designed for persons who are color-blind, and in this variant, a sequence of patterns is displayed to the examinee. A random number variant is also designed for color-blind persons, and in this variant, random numbers are displayed to the examinee. For persons whose visual impairment is substantial, the voice recognition variant may be more suitable. In the voice recognition variant, a speaker in the device plays out voice objects (e.g., the names of different objects) in a particular sequence. A test matrix is a battery of tests, different tests having different test levels and designed to measure different aspects of memory (such as but not limited to, visual memory, audio memory, and the like). The test level can be defined as the level of difficulty of a test. For example, the test level may be easy, medium or difficult. Test parameters are parameters, which influence the behavior of a test variant. Examples of test parameters are duration between signal tones, length of a signal tone, the speed at which signals are shown to the examinee, etc. Test parameters may change automatically when the test matrix is changed.

In the embodiment of FIG. 1, the examinee selects a test variant and a test matrix using a set of control switches positioned on the control panel 120. The test matrix may also be changed automatically based on the composite scores of the examinee by the control mechanism 125. The control mechanism 125 can be any combination of electronic circuitry and/or a tailored software application embedded in the testing device 100.

In the testing device 100, the sequence generator 115 generates random sequences of signals by associating signals with random numbers generated by a random number generator (not shown). The sequence generator can be, for example, a firmware (a tailored software application embedded in the testing device) There are various ways of generating random numbers, which are well known to persons skilled in the art. The sequence generator generates random sequences of different types of signals for different test variants. For example, if color selection variant is selected, the sequence generator generates signals that are expressed as various sequences of colors, such as red, blue, green, yellow, etc. If pattern selection variant is selected, signals are expressed as various patterns. If random number variant is selected, the sequence of random numbers is displayed directly on the display panel 110. If voice recognition variant is selected, the signals are expressed as voice objects. Each signal can include a variety of components, such as but not limited to, a visual component, an auditory component, a positional component, and/or a tactile component. Each signal can be represented by a button/switch positioned on the operative panel 130. A visual component can be further composed of a color subcomponent and a light intensity subcomponent. An auditory component can be further composed of a frequency range subcomponent and a sound intensity subcomponent. A positional component can be shown by a position on the testing device 100, and a tactile component can be represented by a distinct pattern of vibrations.

Depending on the test variant selected, the testing device 100 plays out different types of signal sequences to the examinee. The examinee recalls the sequence of signals and attempts to input the same sequence using the operative panel 130. The operative panel 130, used by the examinee to input the sequence of signals, may include one or more of buttons, switches, etc., a keypad with alphabetical and/or numerical keys, a microphone and the like.

Test outcome variables measure the actions and timings of the inputs entered by the examinee into the testing device. Examples of test outcome variables are total string length, period before starting input, periods between inputs, error ratio, pre-error string length, etc. The total string length can be defined as the number of signals in a sequence of signals. The period before starting input can be defined as the time taken by the examinee before his first input. The period between the inputs is the time taken by the examinee between inputting two consecutive signals. The pre-error string length can be defined as total number of correct signal inputs given before the examinee makes an error. The error ratio can be computed by dividing total number of errors by the total string length. The test outcome variables may be measured using a variety of measuring techniques, for example, a stop watch, a timer, a counter, other electronic circuitry, etc. which are well known in the art.

A score-computing module 160 computes a composite memory score (hereinafter called composite score) based on test variant, test parameters, and test outcome variables. The score-computing module 160 can be a tailored software application embedded in the device. The composite score may be calculated using data based on the values of the test parameters, the test outcome variables, and the normalization factors for age, gender, and learning effect. The composite score may have a positive or negative correlation with different test parameters and test outcome variables. For example, if there is increase in the average period between the inputs of the examinee, this results in a decrease in the composite score. The score-computing module may also reside on a remote server in some embodiments.

The composite score may be stored in a memory medium 140 (for example, a flash memory, a USB memory, an optical memory disk, a smart card etc.) The composite score can be transmitted to an external device (for example, a remote server, a mobile phone, a personal computer, etc.), using a communication interface 150 such as a modem, a wired network interface, a wireless network interface, etc. The testing device 100 may have a time-controlled data uploading application, which uploads the stored test data to the external device automatically after a predefined time-period. The composite score can be displayed to the examinee using a display mechanism 110 such as a display panel, etc. The control mechanism 125 may change the test matrix automatically, based on the composite score of the examinee.

The testing device 100 may double up as a mentally stimulating fun game to enhance memory of the examinee and as a memory-improving device for an individual suffering from dementia and other cognitive diseases. The testing device 100 may be used with mains power or battery power. The batteries used in the testing device may be rechargeable.

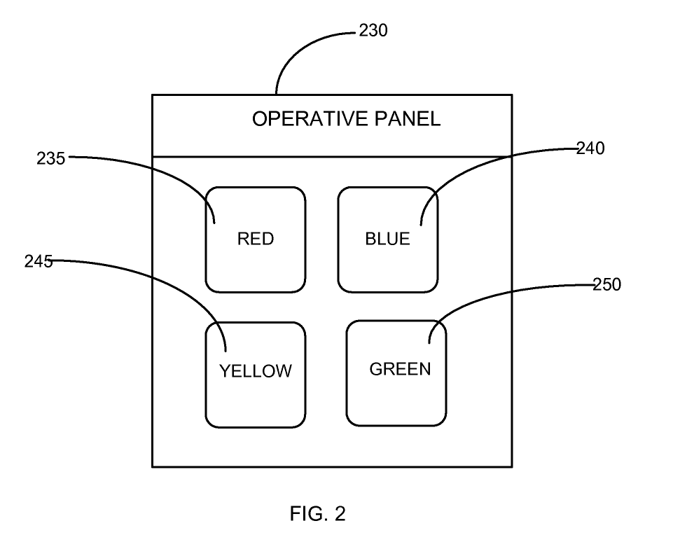

FIG. 2 shows an embodiment of an operative panel 230 of a testing device. In this embodiment, the operative panel 230 includes a set of buttons 235, 240, 245, and 250. If the examinee opts for the color selection variant, the sequence generator will generate a sequence of colors. The illustration is by way of an example and should not be limited to the scope of the example.

### FOR EXAMPLE

The examinee opts for the color selection variant. The sequence generator will generate a sequence of colors. The button 235 may blink first showing the red color, followed by the button 245 showing the yellow color, then the button 240 showing the blue color, and finally the button 250 showing the green color. The examinee recalls the sequence of colors and presses the button 235, followed by the button 245, the button 240, and the button 250 respectively as his input. The test device 100 based on the test variant, test parameters and the test outcome variables calculate the composite memory score. In an embodiment, after successful completion of a test of a specific string length (number of signals in the sequence), the testing device 100 may increases the string length in the next test. In other embodiments, the string length may be increased only after completion of a specified number of tests having the same string length.

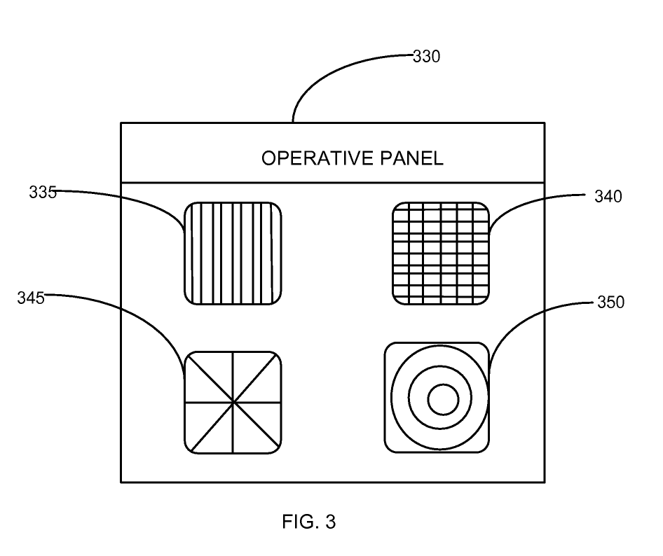

FIG. 3 shows an embodiment of an operative panel 330 including a set of buttons 335, 340, 345, and 350. If the examinee opts for pattern selection variant, the sequence generator will generate a sequence of patterns. The illustration is by way of an example and should not be limited to the scope of the example.

### FOR EXAMPLE

The examinee opts for the pattern selection variant. The patterns can be of any type, such as parallel lines pattern, concentric circle pattern, square patterns, intersecting lines pattern, and the like. The sequence generator will generate a sequence of patterns. The button 335 may blink first showing the first pattern, followed by the button 345 showing the second pattern, followed by the button 340 showing the third pattern, and finally followed by the button 350 showing the fourth pattern. The examinee will recall the sequence of patterns and will press the button 335, followed by the button 345, the button 340, and the button 350 respectively as his input. The test device 100 based on the test variant, test parameters and the test outcome variables calculate the composite memory score.

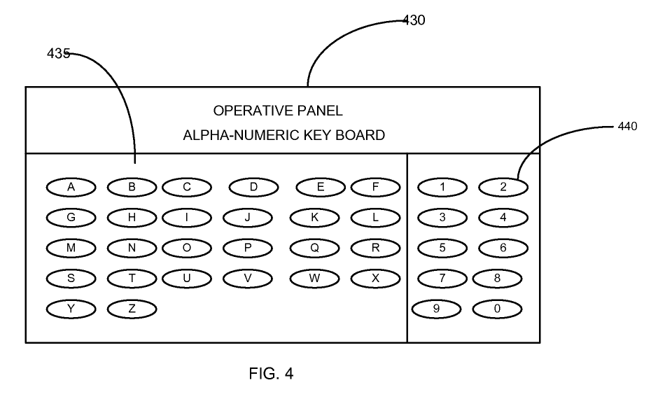

FIG. 4 shows an embodiment of an operative panel 430 including an alphabetical keypad 435 and a numerical keypad 440. If the examinee opts for random number variant, the sequence generator will generate a set of random numbers. The illustration is by way of an example and should not be limited to the scope of the example.

### FOR EXAMPLE

The examinee opts for the random number variant. The sequence generator will generate a sequence of random numbers, say 486732 and display the same sequence on the display panel. The examinee based on the sequence of random number will key-in his input using the keys 4, 8, 6, 7, 3, and 2 on the numeric keypad 435. The test device 100 based on the test variant, test parameters and test outcome variables calculate the composite memory score.

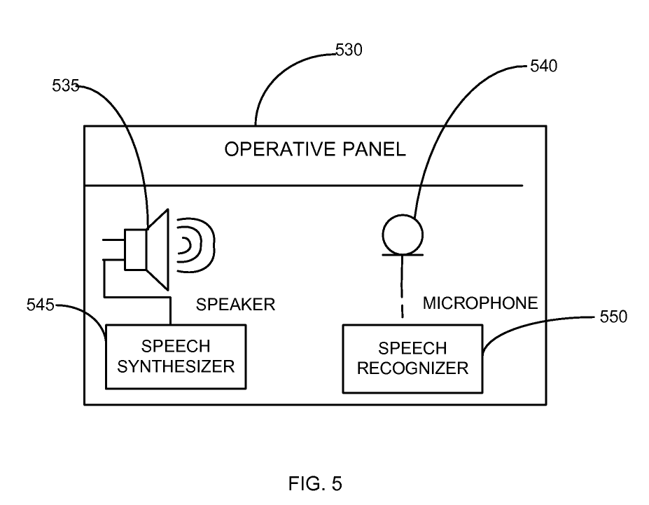

FIG. 5 shows an embodiment of an operative panel 530 including a speech synthesizer 545, a speaker 535, a microphone 540, and a speech recognition module 550. If the examinee opts for the voice recognition variant, the sequence generator will generate a sequence of voice objects of varying tone ranges. It is known that people may lose their sensitivity to audio signals of certain frequencies as they age. In an embodiment, the desired frequency range may be automatically selected depending on the age of the examinee retrieved from the examinee personal data submitted by the examinee or his/hereinafter sponsor at the time of subscription to the services described in this application The illustration is by way of an example and should not be limited to the scope of the example.

### FOR EXAMPLE

The examinee opts for the voice recognition variant. The sequence generator will generate a sequence of voice objects of varying tone ranges, for example, “apple”, “orange”, “mango”, etc. and plays them out to the examinee using the speaker 535. The examinee will recall the voice objects and will input the same voice objects in the same order using the microphone 540. The speech recognition module will compare the examinee's recital with the voice objects recited by the device and calculate the composite memory score based on the test parameters and the test outcome variables.

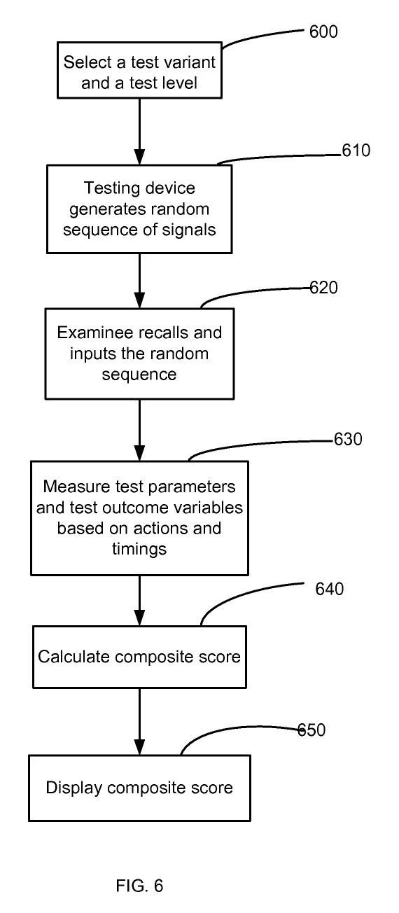

FIG. 6 shows a flow diagram illustrating an exemplary process flow for working of a memory testing device 100.

In step 600, an examinee selects a test variant and test matrix.

In step 610, a sequence generator present in the testing device generates a random sequence of signals.

In step 620, an examinee recalls the sequence of signals and inputs the same sequence using an operative panel using a plurality of buttons, switches, etc. Each button/switch corresponds to a predefined signal.

In step 630, the test outcome variables and test parameters are measured based on the actions and timings.

In step 640, the score-computing module computes the composite score based on the test outcome variables and the test parameters.

In step 650, composite score calculated by the score-computing module are displayed to the examinee using a display panel.

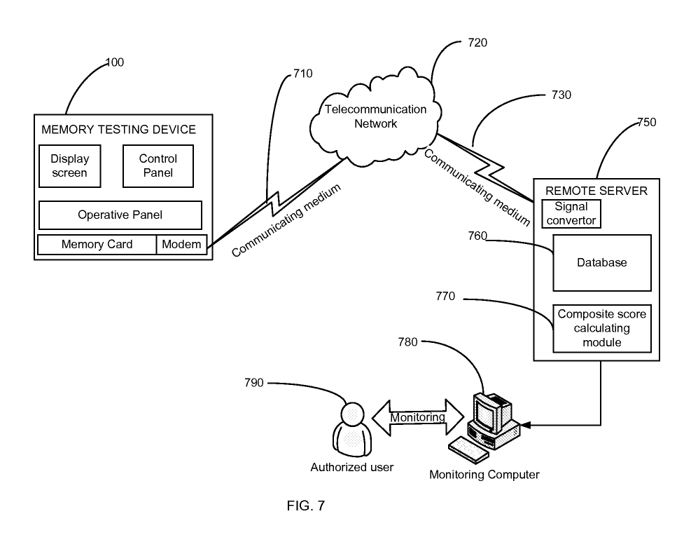

FIG. 7 shows an architectural view of an embodiment of a system for recording, transmitting, and displaying composite scores. The testing device 100 includes a sequence generator 115, a display panel 110, an operative panel 130 with a plurality of buttons, switches, etc., a memory medium 140, a control mechanism 125, a control panel 120 with a set of control switches, and a communication interface 150. The sequence generator generates a sequence of signals. An examinee recalls the sequence and inputs the same sequence using the operative panel 130. The test parameters and test outcome variables may be recorded in the memory medium 140.

The recorded test parameters and test outcome variables can be transmitted to a database 760 residing over a remote server 750 through a telecommunication network 720 using the communication interface 150 (such as a modem, a wired network interface, a wireless network interface, etc.) Examples of the wired network interface are an RJ 11 jack for telephone or an RJ 45 jack for network connections. The recorded test parameters and test outcome variables can be sent through a communicating medium which can be wired or wireless depending upon the type of telecommunication network 720 used for transmission. The wired communication can be done using a communicating cable 710 (for example, an unshielded twisted pair cable, a shielded twisted pair cable, a coaxial cable, a fiber optic cable and the like). The telecommunication network 720 can be any telephone-communicating network such as but not limited to the public switched telephone network (PSTN), the global system for mobile communication network (GSM), the code division multiple access network (CDMA) and the like. The recorded test outcome variables can be transmitted a remote server 750 using the telecommunication network 720. The remote server 750 may include a database 760 and a score-computing module 770. The remote server 750 can be used for computing the composite memory score using the score-computing module 470, storing the test outcome variables and composite memory score for record and for computing composite score time series, composite score trend charts for each examinee.

The remote server 750 can be connected to a monitoring computer (an internet capable device) 780, such as a PC, laptop, Desktop, PDA and the like, of an authorized user 790 for monitoring the progress of memory of the examinee. The remote server 750 can be accessed using a public computer network (such as internet, etc) or a private computer network (such as intranet, etc). The authorized user 790 can be any authorized person such as children or family of the examinee, medical practitioner, researcher, government authorities and the like. In an embodiment, a medical practitioner may remotely change the test matrix on an internet capable device (e.g., a personal computer, etc.). This changes the test matrix stored in the examinee's record in the central database storing examinee personal data, test outcome variables, composite score data, and test matrices of all the examinees. When the testing device establishes a connection with the central database, the changed test matrix gets downloaded automatically to the testing device. During the subscription process the examinee or the authorized user may enter examinee personal data, e.g., age, gender, physiological limitations, etc. The examinee personal data may be used by the system to automatically select the initial test variant and the initial test matrix. The examinee personal data may also be used to compute the normalization factors for age, gender, etc.

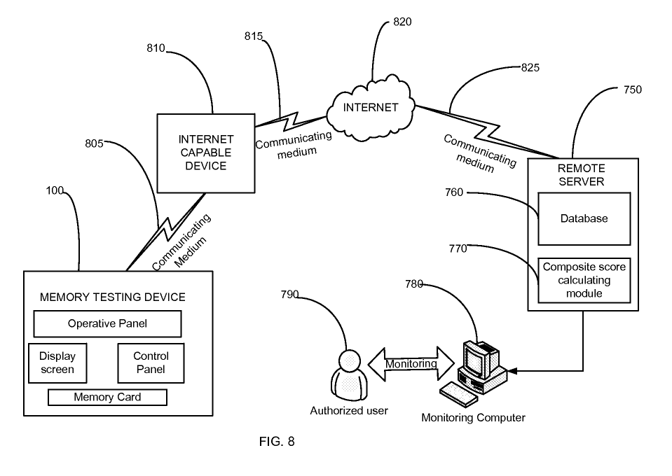

FIG. 8 shows an architectural view of an embodiment. The testing device includes a sequence generator 115, a display panel 110, an operative panel 130 with a plurality of buttons, switches, etc., a memory medium 140, a control mechanism 125, a control panel 120 with a set of control switches, and a communication interface 150. The sequence generator 115 generates a sequence of signals. An examinee recalls the sequence and inputs the same sequence using the operative panel 130. The test outcome variables based on the actions and timings of the testing device 100 and that of the examinee can be recorded in the memory medium 140.

The recorded test parameters and test outcome variables can be transmitted through an internet network 820. The testing device 100 can be connected to a local computer 810 using a communicating media 805 such as a wired communication (for example network cable), a Bluetooth, and/or an infrared protocol. The local computer 810 can be connected to the internet network 820 using a communicating media 815, such as but not limited to, a modem, a wired network and/or a wireless network. The recorded test parameters and test outcome variables can be transmitted to the remote server 750 through the internet work 820. The remote server 750 may include a database 760 and a score-computing module 770. The remote server 750 can be used for computing the composite memory score using the score-computing module 770, storing the test parameters and test outcome variables and composite memory score for recording and for computing composite score time series, composite score trend charts for each examinee.

The remote server 750 can be connected to a monitoring computer (an internet capable device) 780, such as a PC, laptop, Desktop, PDA and the like, of an authorized user 790 for monitoring the progress of memory of the examinee. The authorized user 790 can be children or family of the examinee, a medical practitioner, a researcher, government authorities and the like. The authorized person can remotely change the test matrix stored on database and the changed test matrix can be communicated to the testing device of the examinee. During the subscription process the authorized user can enter the age, gender, physiological limitations, etc. of the examinee in order to customize the testing device as per the needs of the examinee.

In other embodiments of the invention, the functionality of the physical testing device 100 may be realized by a virtual testing application enabled by source code. The virtual testing application can be designed to operate on different devices having a microprocessor and a memory (for example, a PC, laptop, Desktop, PDA, mobile phone, etc.).

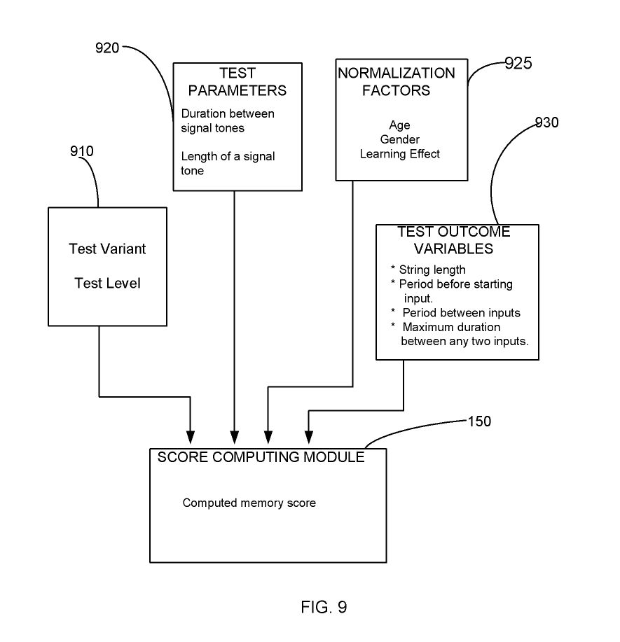

FIG. 9 shows an overview of the process for calculation of a composite score by the score-computing module 150. The score computing module 150 computes the memory score based on the test variant 910, the test parameters 920, and the test outcome variables 930. The test variant 910 can be selection of colors, patterns, random numbers, and/or voice recognition etc. The test parameter 920 can be,interval between signal tones, length of signal tone, etc. The composite score needs to be normalized for the age and gender of the examinee 925. The test outcome variable 930 can be string length, duration before starting input, average duration between inputs, and maximum duration between any two inputs, etc.

The composite score may have a positive or negative correlation with different test parameters and test outcome variables. If with the increase in one variable and/or parameter there is decrease in the score it can be termed as negative correlation. Similarly if with the increase in one variable and/or parameter there is increase in the score, it will be termed as positive correlation.

If the string length in any test increases, then irrespective of increase or decrease in the duration between the signal tones and the length of signal tones, the score increases, this can be termed as positive correlation. If duration before starting input, average duration between inputs and maximum duration between any two inputs decreases, the score increases, this can be termed as negative correlation and the like. Similarly, if there is a variation in the test parameters such as duration between a signal tones and length of a signal tone, the composite score also gets affected.

In addition, the composite memory score can be affected based on a pre-error string length as well as an error ratio. The illustration is by way of an example and should not be limited to the scope of the example.

### FOR EXAMPLE

The sequence generator generates a sequence of signals with string length 15. The examinee recalls the sequence and inputs the same sequence. The testing device will take all the 15 inputs without restricting the examinee if he has entered a wrong signal as his input. In a test, the sequence generator has generated a sequence of signals with string length 15. The examinee after recalling the sequence has entered 12 signals correctly followed by 1 wrong signal and again 2 signals correctly, as his input. Thus, the pre- error string length in this example is 12, and the error ratio is calculated as total number of wrong signals entered divided by total string length. The composite score can be calculated based on the values obtained as pre-error string length and error ratio.

Having fully described the preferred embodiment, other equivalent or alternative methods of testing memory of an examinee according to the present invention will be apparent to those skilled in the art. The invention has been described above by way of illustration, and the specific embodiment disclosed is not intended to limit the invention to the particular forms disclosed. For example, the embodiments described in the foregoing were directed to providing you clear ideas about the preferred modes, including the best mode, of making and using the present invention; however, in alternate embodiments, those skilled in the art may implement the invention using various other means without deviating from the central idea of the invention. The invention therefore covers all modifications, equivalents, and alternatives falling within the spirit and scope of the following claims.

I claim:

1. A memory testing device for conducting memory measurement tests based on memorizing random sequences of signals, the testing device comprising:
means for measuring test outcome variables for a test variant and a test matrix for an examinee;
a score computing module for computing the composite score based on based on at least one of the test matrix, the test outcome variables, and normalization factors for learning effect, age, and gender of the examinee;
a memory medium for storing the test outcome variables and the composite score of the examinee; and
a display panel for displaying the test outcome variables and the composite score of the examinee.

2. The testing device of claim 1, further comprising:
a communication interface for communicating between said memory medium of said testing device and a database residing on a remote server; and
means for automatically transferring the stored test outcome variables and the stored composite score data from said memory medium to the database, the database storing at least one of examinee personal data, the test outcome variables, the composite score data and test matrices for all examinees.

3. The testing device of claim 1, wherein the communication interface is a modem, a wired network interface, or a wireless network interface.

4. The testing device of claim 1, further comprising:
a sequence generator module including a random number generator component for generating and displaying a random sequence of signals to the examinee, wherein each signal comprises at least one of a visual component, an auditory component, a positional component, and a tactile component, and wherein the visual component comprises at least one of a color subcomponent, a light intensity subcomponent, and a pattern subcomponent; and
an operative panel including a plurality of buttons positioned on said operative panel, each button representing a specific signal, the buttons to be selected by the examinee in the same order as the memorized sequence of signals.

5. The testing device of claim 1, further comprising:
a random number generator for generating and displaying a random sequence of alphanumeric characters to the examinee; and
a keypad for enabling the examinee to input the memorized sequence of alphanumeric characters into said testing device.

6. The testing device of claim 1, further comprising:
a speech synthesizer module for generating voice objects;
a sequence generator module including a random number generator component for generating a sequence of the voice objects;
a speaker for reciting the sequence of voice objects of varying tone ranges;
a microphone for the examinee to recite the memorized sequence of voice objects; and
a speech recognition module for deciphering the spoken voice objects.

7. The testing device of claim 1, wherein the score computing module includes the steps of computing the composite score based on at least one of test matrix, test outcome variables, and normalization factors for learning effect, gender, and age.

8. The testing device of claim 1, further comprising a control mechanism for changing the test variant and the test matrix and for selecting any combination of visual, auditory, positional, and vibratory signals.

9. The testing device of claim 8, wherein the control mechanism automatically changes the test variant based on physiological limitations of the examinee and automatically changes the test matrix based on the composite score data of the examinee.

10. The testing device of claim 4, wherein the test outcome variables to be measured comprise at least one of total string length, period before starting input, periods between inputs, error ratio, and pre-error string length.

11. A system for conducting memory measurement tests and for recording, transmitting, and displaying test data and test trends, the system comprising:
a memory testing device including a score computing module for computing composite memory scores, a memory medium and a communication interface;
a database residing on a remote server for receiving test data from the memory medium of said testing device, the database storing at least one of examinee personal data, the test outcome variables, the composite score data and test matrices for all examinees.; and
an internet capable device for an authorized user to remotely access the composite score data of an examinee and to remotely change the test matrix on the testing device of the examinee.

12. The system of claim 11, wherein the test data are transmitted from the memory medium of said testing device to said database via a telecommunications network.

13. The system of claim 11, wherein the test data are transmitted from the memory medium of said testing device to said database via an internet connection.

14. The system of claim 11, further comprising an internet-connectable device wherein the test data are first transmitted from the memory medium of said testing device to said internet-connectable device and wherein the test data are further transmitted from said internet-connectable device to the remote server via an internet connection.

15. The system of claim 11, wherein said memory testing device further comprises:
a sequence generator module including a random number generator component for generating a random sequence of signals wherein each signal comprises at least one of a visual component, an auditory component, a positional component, and a tactile component, and wherein the visual component comprises at least one of a color, a light intensity, and a pattern; and
a plurality of buttons corresponding to different signals, the buttons to be selected by the examinee in the same order as the memorized sequence of signals.

16. The system of claim 11, wherein the testing device further comprises a control mechanism for enabling automatic change of test matrix based on at least one of composite score data and physiological limitations of the examinee.

17. A method for conducting memory measurement tests and for recording, transmitting and displaying results, the method comprising the steps of:
selecting a test variant and a test matrix;
measuring test outcome variables based on actions and timings of an examinee;
computing at least one of composite memory scores, composite score time series, and composite score trend charts, based on at least one of the test matrix, the test outcome variables, and normalization factors for learning effect, age, and gender of the examinee;
recording the test outcome variables and the composite memory score data of the examinee in a memory medium; and
automatically transferring via a communication interface the test outcome variables and the composite memory score data from the memory medium to a database residing on a remote server, the database storing at least one of examinee personal data, the test outcome variables, the composite score data, and test matrices for all examinees.

18. The method of claim 17, further comprising the step of displaying the stored test outcome variables and the composite score data to authorized persons connecting to the database through a web browser residing on an internet capable device.

19. The method of claim 17, further comprising the step of automatically changing the test variant based on physiological limitations of the examinee and automatically changing the test matrix based on the composite score data and of the examinee.

20. The method of claim 17, further comprising the step of remotely changing the test matrix of the examinee by an authorized user connecting to the database through a web browser residing on an internet capable device.
